(19) United States
(12) Patent Application Publication
(10) Pub. No.: US 2018/0157814 A1
(43) Pub. Date: Jun. 7, 2018

(54) PERSONAL AUTHENTICATION METHOD AND APPARATUS BASED ON RECOGNITION OF FINGERTIP GESTURE AND IDENTIFICATION OF FAKE PATTERN

(71) Applicant: ELECTRONICS AND TELECOMMUNICATIONS RESEARCH INSTITUTE, Daejeon (KR)

(72) Inventors: Jang-Hee YOO, Daejeon (KR); Ki-Young MOON, Sejong-si (KR); Young-Jae LIM, Daejeon (KR); Kyo-Il CHUNG, Daejeon (KR)

(73) Assignee: ELECTRONICS AND TELECOMMUNICATIONS RESEARCH INSTITUTE, Daejeon (KR)

(21) Appl. No.: 15/813,384

(22) Filed: Nov. 15, 2017

(30) Foreign Application Priority Data
Dec. 1, 2016 (KR) 10-2016-0162686
Sep. 6, 2017 (KR) 10-2017-0114070

(51) Int. Cl. G06F 21/32; G06F 21/45; G06F 3/01; G06K 9/00; G06F 3/0488

(52) U.S. Cl. CPC G06F 21/32; G06F 21/45; G06F 3/017; H04W 12/06; G06K 9/00389; G06K 9/00926; G06F 3/04883; G06K 9/00382

(57) ABSTRACT

Disclosed herein are a method and apparatus for authenticating a user based on a fingertip gesture. The authentication apparatus may display a pattern generated based on geometric information about a hand geometry or size of a user, and may recognize a fingertip gesture via interaction with the user with respect to the pattern. The authentication apparatus may authenticate a user using the recognized fingertip gesture. The pattern may include a gesture inducement/relation pattern and a fake pattern. Information about the fingertip gesture may include fingertip touch locations of the fingertip gesture, a touch order of the fingertip touch locations, and a moving direction of the fingertip touch locations.

### CROSS REFERENCE TO RELATED APPLICATIONS

This application claims the benefit of Korean Patent Application Nos. 10-2016-0162686, filed Dec. 1, 2016 and 10-2017-0114070, filed Sep. 6, 2017, which are hereby incorporated by reference in their entirety into this application.

### BACKGROUND OF THE INVENTION

### 1. Technical Field

The following embodiments relate generally to a method and apparatus for personal authentication and, more particularly, to a personal authentication method and apparatus based on recognition of a fingertip gesture and identification of a fake pattern.

### 2. Description of the Related Art

Various methods for personal identification and personal authentication have been developed and used.

In order to more securely protect important assets, effort to improve security in personal authentication has been made, and efforts to improve convenience together with security have become an important issue in the field of personal authentication technology.

Personal authentication has been used to control the usage of smart devices and control access to buildings and the like.

In relation to such usage control and access control, as various conventional methods for authenticating respective individuals, methods based on a password, a numeric-pad-based pattern lock, a random keyboard, a Personal Identification Number (PIN), or a smart card have been used.

A password, a pattern lock, or a PIN is disadvantageous in that a user can easily forget the password, patterns or numbers or can easily leak the password, patterns or numbers.

A static pattern lock or a random keyboard, which is mainly used in mobile devices, can also be easily leaked by shoulder surfing or the like.

As more advanced schemes for solving various problems involved in those methods, biometrics technology that exploits various types of biometric information, such as a fingerprint, an iris, a face, a finger vein, a blood vessel on the back of a hand, and hand geometry, for personal authentication has been used.

Biometrics technology may be a strong personal authentication means. However, personal authentication that exploits biometric information generally requires the use of an additional sensor for stably acquiring biometric information. Further, since biometric information is unchangeable throughout a user's lifetime and all persons have unique and different biometric features, personal biometric information cannot be deleted, changed or reissued once the personal biometric information is leaked. Furthermore, a problem arises in that it is difficult to technically respond to the leakage of biometric information.

In order to solve this problem, personal authentication based on soft biometrics or semi-biometrics and a mechanism for strengthening the security of such personal authentication are required.

### PRIOR ART DOCUMENTS

### Patent Documents

(Patent Document 1) Korean Patent Application Publication No. 10-2013-0072606 (Date of publication: Jul. 2, 2013, entitled “Apparatus for Providing Input Interface and Operating Method Thereof”)

### SUMMARY OF THE INVENTION

An embodiment is to provide an apparatus and method for providing a pattern that enables interaction with a user based on the geometric range of a hand geometry and/or a hand size when biometric information about the hand geometry and/or the hand size is enrolled via a touch screen.

An embodiment is to provide an apparatus and method for authenticating a user via continuous interaction with a pattern and a fingertip gesture.

An embodiment is to provide an apparatus and method for authenticating a user using gesture inducement/relation patterns and fake patterns which are displayed either in a predefined order or in a random order.

An embodiment is to provide an apparatus and method for authenticating a user, which exploit both biometric information about a hand geometry and/or a hand size, each of which has uniqueness insufficient to identify each individual, and a fingertip gesture, which is capable of supplementing the biometric information.

An embodiment is to provide an apparatus and method for simultaneously providing advantages, such as convenience of use, which is provided by a conventional personal authentication method using a password or a PIN, and strengthened security, which is provided by a conventional biometrics method, by exploiting both the biometric information and the fingertip gesture.

An embodiment is to provide an apparatus and method for continuously recognizing various fingertip gestures that are reissuable and regenerable to strengthen safety and security, based on soft biometrics using biometric information about a hand geometry and/or a hand size.

An embodiment is to provide an apparatus and method for more securely and efficiently authenticating a user via soft biometrics and recognition of fingertip gestures.

An embodiment is to provide an apparatus and method for authenticating a user without using an additional sensor by utilizing a touch screen, widely used in various products, technologies and applications, without change.

An embodiment is to provide an apparatus and method for authenticating a user, which may be implemented without modifying or adding hardware in existing smart devices, computer systems, Automated Teller Machine (ATM) devices, and access control systems that use touch screens.

In accordance with an aspect, there is provided an authentication method, including identifying a user; displaying a pattern generated based on geometric information about a hand geometry or a hand size of the identified user; recognizing a fingertip gesture via interaction with the user with respect to the pattern; and authenticating the user using the recognized fingertip gesture.

Identifying the user may be configured to search for information about candidate users matching input hand information by exploiting the input hand information.

The hand information may include geometric information about hand geometry or hand morphology.

The pattern may be a gesture inducement/relation pattern.

The gesture inducement/relation pattern may be a pattern for acquiring a fingertip gesture enrolled by the user.

Recognizing the fingertip gesture may include sensing fingertip touch locations of an input fingertip gesture; sensing a moving direction of the fingertip touch locations; and determining whether the input fingertip gesture is a gesture that has been successfully made with respect to the gesture inducement/relation pattern by comparing similarity between the information about the input fingertip gesture and information about the enrolled fingertip gesture,

The information about the input fingertip gesture may include the fingertip touch locations and the moving direction.

If a result of a quantitative similarity comparison, produced through a comparison between the information about the input fingertip gesture and the information about the enrolled fingertip gesture, is equal to or greater than a predefined reference value, it may be determined that the input fingertip gesture has been successfully made.

The information about the input fingertip gesture may further include a touch order of the fingertip touch locations.

A specific entity may be displayed as a background together with the gesture inducement/relation pattern.

The entity may indicate one or more points.

Each of the one or more points may be a region that is separately identifiable within the entity.

The one or more points may be generated based on the geometric information about the hand geometry or the hand size of the user.

The one or more points may correspond to locations of the fingertips of the user depending on the geometric information about the hand geometry or the hand size of the user.

The pattern may disappear either at a moment at which the fingertip gesture is made or if a predefined time elapses after the fingertip gesture is made.

The pattern may be a fake pattern.

The fake pattern may be a pattern for acquiring a predefined fingertip gesture.

In accordance with another aspect, there is provided a method for enrolling authentication information, including enrolling information for identifying a user; and enrolling a fingertip gesture of the user, wherein information for identifying the user includes geometric information about a hand geometry or a hand size of the user.

The method may further include selecting a type of enrollment information related to the fingertip gesture,

The enrollment information may be background-based enrollment information or non-background fingertip point-based enrollment information.

Enrolling the fingertip gesture may include enrolling a background and fingertip touch locations of the fingertip gesture; and enrolling a moving direction of the fingertip touch locations.

Enrolling the fingertip touch locations may be configured such that, when one or more points in an entity of the background are displayed, one or more fingertip touch locations are selected from among the one or more points and then enrolled.

The entity may have a size or a shape that is generated or adjusted based on the geometric information about the hand geometry or the hand size of the user.

Enrolling the fingertip touch locations may be configured to enroll a touch order of the one or more fingertip touch locations of the fingertip gesture.

Enrolling the fingertip gesture may include enrolling fingertip touch locations of the fingertip gesture; and enrolling a moving direction of the fingertip touch locations.

Enrolling the fingertip touch locations may be configured to display one or more points, select one or more fingertip touch locations from among the one or more points, and enroll the selected one or more fingertip touch locations.

Locations of the one or more points may be generated or adjusted based on the geometric information about the hand geometry or the hand size of the user.

In accordance with a further aspect, there is provided an authentication apparatus, including a display for displaying a pattern generated based on geometric information about a hand geometry or a hand size of a user; and a processor for recognizing a fingertip gesture via interaction with the user with respect to the pattern and authenticating the user using the recognized fingertip gesture.

In addition, there are provided other methods, apparatuses, and systems for implementing the present disclosure, and a computer-readable storage medium storing a computer program for executing the method.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a configuration diagram of an authentication apparatus according to an embodiment;

FIG. 2 illustrates functions of a processor according to an embodiment;

FIG. 3 illustrates personal authentication that exploits both biometric information about a hand geometry and/or a hand size and a fingertip gesture based on a touch screen according to an embodiment;

FIG. 4 is a configuration diagram of a personal authentication system based on recognition of hand geometry and a fingertip gesture in a touch screen environment according to an embodiment;

FIG. 5 is a flowchart of an authentication method according to an embodiment;

FIG. 6 is a flowchart illustrating a method for enrolling authentication information according to an example;

FIG. 7 is a flowchart illustrating a method for enrolling background-based enrollment information according to an example;

FIG. 8 is a flowchart illustrating a method for enrolling non-background fingertip point-based enrollment information according to an example;

FIG. 9 is a flowchart illustrating a method for authenticating a user according to an embodiment;

FIG. 10 is a flowchart illustrating a method for identifying a user according to an embodiment;

FIG. 11 is a flowchart illustrating a method for recognizing a fingertip gesture with respect to a gesture inducement/relation pattern according to an embodiment; and

FIG. 12 is a flowchart illustrating a method for recognizing a fingertip gesture with respect to a fake pattern according to an embodiment.

### DESCRIPTION OF THE PREFERRED EMBODIMENTS

Detailed descriptions of the following exemplary embodiments will be made with reference to the attached drawings illustrating specific embodiments. These embodiments are described so that those having ordinary knowledge in the technical field to which the present disclosure pertains can easily practice the embodiments. It should be noted that various embodiments are different from each other, but do not need to be mutually exclusive to each other. For example, specific shapes, structures, and characteristics described here may be implemented as other embodiments without departing from the spirit and scope of the embodiments in relation to an embodiment. Further, it should be understood that the locations or arrangement of individual components in each disclosed embodiment can be changed without departing from the spirit and scope of the embodiments. Therefore, the accompanying detailed description is not intended to restrict the scope of the disclosure, and the scope of the exemplary embodiments is limited only by the accompanying claims, along with equivalents thereof, as long as they are appropriately described.

In the drawings, similar reference numerals are used to designate the same or similar functions in various aspects. The shapes, sizes, etc. of components in the drawings may be exaggerated to make the description clear.

The terms used in the present specification are merely used to describe specific embodiments and are not intended to limit the present disclosure. A singular expression includes a plural expression unless a description to the contrary is specifically pointed out in context. In the present specification, it should be understood that terms such as “comprises” or “comprising” are merely intended to indicate that features, numbers, steps, operations, components, parts, or combinations thereof are present, and are not intended to exclude the possibility that one or more other features, numbers, steps, operations, components, parts, or combinations thereof will be present or added, and additional components may be included in the scope of the practice of exemplary embodiments or the technical spirit of the exemplary embodiments. It will be understood that when a component is referred to as being “connected” or “coupled” to another component, it can be directly connected or coupled to the other component, or intervening components may be present. Further, it should be noted that, in exemplary embodiments, the expression describing that a component “comprises” a specific component means that additional components may be included in the scope of the practice or the technical spirit of exemplary embodiments, but do not preclude the presence of components other than the specific component.

Terms such as “first” and “second” may be used to describe various components, but the components are not restricted by the terms. The terms are used only to distinguish one component from another component. For example, a first component may be named a second component without departing from the scope of the present disclosure. Likewise, a second component may be named a first component.

Also, components described in the embodiments are independently shown in order to indicate different characteristic functions, but this does not mean that each of the components is formed of a separate piece of hardware or software. That is, components are arranged and included separately for convenience of description. For example, at least two of the components may be integrated into a single component. Conversely, one component may be divided into multiple components. An embodiment into which the components are integrated or an embodiment in which some components are separated is included in the scope of the present specification as long as it does not depart from the essence of the present specification.

Further, some components are not essential components for performing essential functions, but may be optional components for improving only performance. The embodiments may be implemented using only essential components for implementing the essence of the embodiments. For example, a structure including only essential components, excluding optional components used only to improve performance, is also included in the scope of the embodiments.

Embodiments will be described in detail below with reference to the accompanying drawings so that those having ordinary knowledge in the technical field to which the embodiments pertain can easily practice the embodiments. In the following description of the embodiments, detailed descriptions of known functions or configurations which are deemed to make the gist of the present specification obscure will be omitted.

In the following embodiments, there are provided a personal authentication method and apparatus based on the recognition of continuous fingertip gestures so as to solve various problems related to conventional personal authentication technology. Here, the recognition of continuous fingertip gestures may mean that fingertip touch locations of a fingertip gesture, the touch order of the fingertip touch locations, and the moving direction of the fingertip touch locations are recognized.

Recently, a touch screen has been used in various systems such as computers and access control systems, as well as mobile devices.

In the following embodiments, there are provided a personal authentication method and apparatus based on fingertip gestures that exploit biometric information about a hand geometry and/or a hand size in a touch screen environment in which a touch screen is provided. Fingertip gestures may be continuously recognized by a device via interaction with the device. Interaction between fingertip gestures and the device may be realized based on biometric information about a hand geometry and/or a hand size.

Personal authentication based on the recognition of continuous fingertip gestures may be performed via interaction between a user and an authentication system that uses biometric information about a hand geometry and/or a hand size without requiring an additional sensor in a touch screen environment.

For example, when biometric information about a hand geometry and/or a hand size is input via a touch screen, the authentication apparatus may present a pattern that enables interaction with a user on the touch screen, based on the geometric range of the hand geometry and/or the hand size. Via continuous and correct interaction of fingertip gestures made by the user with respect to the presented pattern, personal authentication may be performed.

Personal authentication using biometric information may be a more advanced scheme than other conventional personal authentication schemes. Personal authentication using biometric information may be excellent technology from the standpoint of security, but may be slightly insufficient technology from the standpoint of convenience of use. In contrast, personal authentication based on other conventional schemes may be excellent technology from the standpoint of convenience of use, but may be slightly insufficient technology from the standpoint of security.

In the following embodiments, there are described a personal authentication method and apparatus for simultaneously utilizing advantages such as the convenience of use provided by other conventional personal authentication schemes and advantages such as the strengthened security provided by personal authentication that uses biometric information. The method and apparatus may more securely and efficiently authenticate each individual by continuously recognizing various fingertip gestures that are reissuable and regenerable to strengthen safety and security, based on soft biometric information.

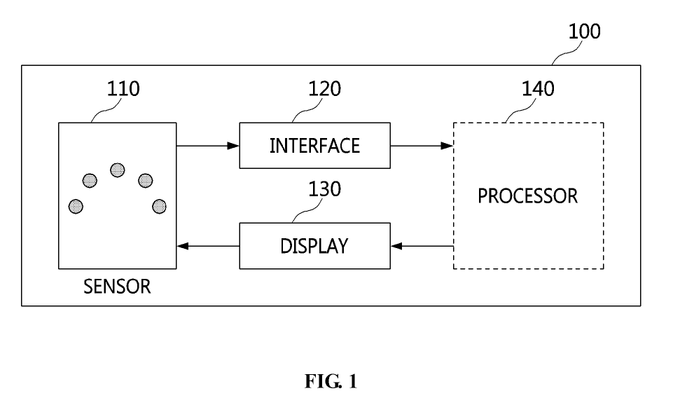

FIG. 1 is a configuration diagram of an authentication apparatus according to an embodiment.

An authentication apparatus 100 may authenticate a user in a touch screen environment. The authentication apparatus 100 may authenticate the user based on biometric information about hand geometry. Also, the authentication apparatus 100 may authenticate the user based on continuous recognition of the user's fingertip gestures that interact with the authentication apparatus 100 at geometric locations and/or in a geometric range based on biometric information about hand geometry.

The authentication apparatus 100 may include a sensor 110, an interface 120, a display 130, and a processor 140.

The sensor 110 may be an input sensing device, such as a touch screen. The sensor 110 may receive a multi-touch input. The sensor 110 or the processor 140 may recognize the hand geometry, hand morphology, and fingertip gesture of the user based on the acquired multi-touch input.

The interface 120 may transmit data sensed by the multi-touch input to the processor 140.

The interface 120 may provide various types of interface functions, such as Universal Serial Bus (USB), IEEE 1394, Local Area Network (LAN), Wi-Fi, Bluetooth and other unique non-standard interfaces.

The sensor 110, the interface 120, and the display 130 may constitute a touch screen display. In other words, the authentication apparatus 100 may include the touch screen display and the processor 140. Hereinafter, operations and functions described as being performed by the sensor 110, the interface 120, and the display 130 may be considered to be performed by the touch screen display.

The display 130 may display a pattern generated based on geometric information about the hand geometry and/or the hand size of the user.

The display 130 may display a gesture inducement/relation pattern, which is generated by the processor 140 and is required for the recognition of a fingertip gesture, to realize interaction between the user and the sensor 110. The user may recognize the displayed gesture inducement/relation pattern and may input a fingertip gesture corresponding to the gesture inducement/relation pattern to the sensor 110.

The gesture inducement/relation pattern may be a pattern for inducing the fingertip gesture of the user within the geometric range of the hand geometry and/or the hand size of the user. For example, the gesture inducement/relation pattern may indicate one or more points or five points which may be touched by the fingers of the user. The points may be determined according to the hand geometry and/or the hand size of the user.

The fingertip gesture may be recognized via interaction with the user with respect to the gesture inducement/relation pattern.

The processor 140 may enroll authentication information used to authenticate the user, and may control the authentication of the user.

The processor 140 may recognize the fingertip gesture of the user with respect to the pattern, and may authenticate the user using the recognized fingertip gesture. The processor 140 may recognize the fingertip gesture via interaction with the user with respect to the pattern.

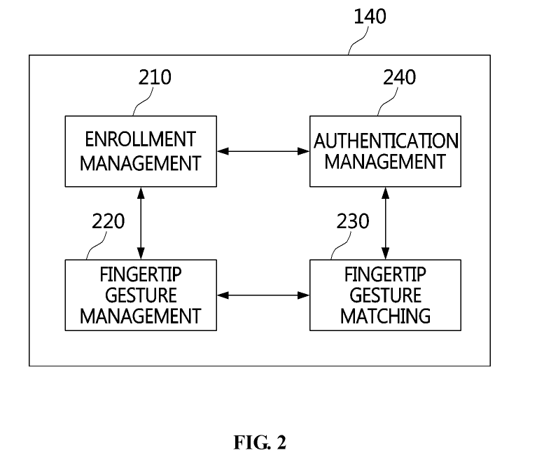

Functions of the processor 140 will be described below with reference to FIG. 2

FIG. 2 illustrates the functions of the processor according to an example.

The processor 140 may perform functions, such as enrollment management 210, fingertip gesture management 220, fingertip gesture matching 230, and authentication management 240. For example, the processor 140 may include a enrollment management module, a fingertip gesture management module, a fingertip gesture matching module, and an authentication management module.

The enrollment management module may enroll a user and the authentication information of the user. The enrollment management module may securely and efficiently manage the authentication information enrolled for the user.

The authentication management module may determine whether the user has been authenticated. The authentication management module may determine whether the user has been authenticated through association with the enrolled authentication information and gesture matching, based on the fingertip gesture.

The fingertip gesture management module may generate a pattern for enrolling the user and authenticating the user based on the geometric information about the hand geometry and/or the hand size. Further, the fingertip gesture management module may process interaction for fingertip gesture recognition.

The fingertip gesture matching module may control matching with various types of fingertip gestures, such as fingertip touch locations and the moving direction of the fingertip touch locations.

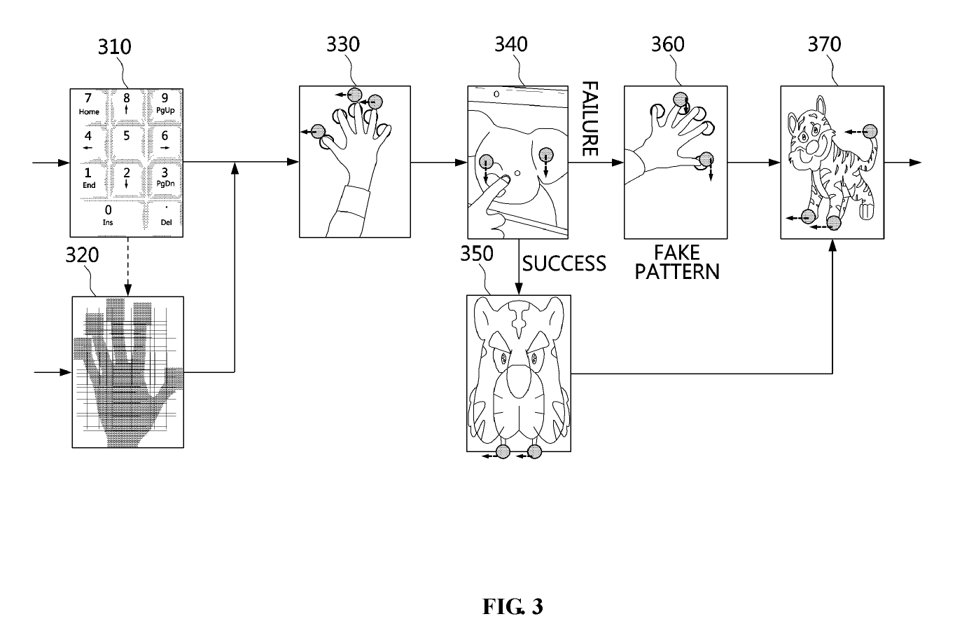

FIG. 3 illustrates personal authentication that exploits biometric information about a hand geometry and/or a hand size and a fingertip gesture based on a touch screen according to an example.

When the user's finger approaches the sensor 110 or the touch screen or touches the sensor 110 or the touch screen, a user ID input screen 310, on which the ID of the user is input, or a hand geometry input screen 320, on which a touch corresponding to the entire hand geometry is induced to be made, may be displayed.

For example, the hand geometry input screen 320 may include an entire hand-shaped contour generated depending on the information about the hand geometry and/or the hand size of the user.

When the authentication apparatus 100 displays the user ID input screen 310, the user may input the enrolled user ID via the touch screen.

When the authentication apparatus 100 displays the hand geometry input screen 320 for inducing an entire hand-shaped touch to be made, the user may input hand geometry biometric information in compliance with the inducement of the displayed hand geometry input screen 320.

For example, the user may place his or her hand within the hand-shaped contour.

Further, according to need, the authentication apparatus 100 may acquire the user's basic information via the user ID input screen 310 and the hand geometry input screen 320. After the user has input his or her ID via the user ID input screen 310, the user may also input the hand geometry biometric information via the hand geometry input screen 320.

As described above, when previously enrolled basic information of the user is input, a fingertip gesture recognition procedure must be performed in order to authenticate the user.

To authenticate the user, the authentication apparatus 100 may display a gesture inducement/relation pattern 330 so as to acquire a fingertip gesture corresponding to the fingertip gesture previously enrolled by the user.

The user may touch one or more fingertip locations previously enrolled on the display or the touch screen on which the gesture inducement/relation pattern 330 is displayed. The one or more fingertip locations that are touched may form an input pattern. Further, the user may move the one or more fingertip locations along a previously enrolled direction, with the one or more fingertip locations being touched.

For example, when the input pattern and the moving direction of the one or more fingertip locations match the information of the previously enrolled fingertip gesture, the authentication apparatus 100 may determine that the input of the user has been successfully made with respect to the gesture inducement/relation pattern. When at least one of the input pattern and the moving direction of the one or more fingertip locations does not match the information of the previously enrolled fingertip gesture, the authentication apparatus 100 may determine that the input of the user has been unsuccessfully made with respect to the gesture inducement/relation pattern.

A procedure for authenticating the user may be composed of multiple steps. At each of the multiple steps, whether the input of the user has successfully or unsuccessfully matched the gesture inducement/relation pattern may be determined.

When the input pattern and the moving direction of the one or more fingertip locations match the information of the previously enrolled fingertip gesture, the authentication apparatus 100 may display a gesture inducement/relation pattern corresponding to a subsequent step.

In other words, the gesture inducement/relation pattern may include multiple successive steps. Pieces of information about fingertip gestures may be enrolled for respective gesture inducement/relation patterns corresponding to multiple steps. The multiple gesture inducement/relation patterns may be randomly generated and displayed regardless of the enrollment order of the pieces of information about the fingertip gestures.

In order for the user to easily remember his or her gesture, background information or an entity that has been previously enrolled or that is similar to the previously enrolled information may be displayed together with the corresponding gesture inducement/relation pattern. By means of the background information or entity, the user may identify which fingertip gesture should be input with respect to the gesture inducement/relation pattern.

In FIG. 3, three pieces of background information 340, 350, and 370 are shown. The background information may be a specific drawing or picture in which a specific shape is indicated at the points which are touched by one or more fingertip locations of the user.

The background information may be information that can provide a hint or help to remember or input fingertip touch locations, the touch order of the fingertip touch locations and/or the moving direction of the fingertip touch locations when the user inputs a fingertip gesture.

For example, the pieces of background information 340, 350, and 370 may include entities. Here, the entities may be animals or characters.

Each entity may indicate one or more points. Each of the one or more points may be a region that can be separately identified within the entity, and may be the target of a touch.

For example, each of at least some of the eyes, nose, mouth, and ears of each animal may be a single point.

For example, the first background information 340 may be a drawing or picture of a koala, and one or more points which are touched by one or more fingertip locations may be the ears of the koala. In other words, when a koala is displayed as the background information of the gesture inducement/relation pattern, the user may recognize that he or she must respectively touch both ears of the koala with his or her fingers and must move the touching fingers downwards.

For example, the second background information 350 may be a drawing or picture of a tiger, and points which are touched by one or more fingertip locations may be the teeth in the face of the tiger. In other words, when the face of a tiger is displayed as the background information of the gesture inducement/relation pattern, the user may recognize that he or she must respectively touch the teeth in the face of the tiger with his or her fingers and must move the touching fingers leftwards.

For example, the fourth background information 370 may be a drawing or picture of the whole body of a tiger, and points which are touched by one or more fingertip locations may be the forefeet and the tail end of the tiger. In other words, when the whole body of a tiger is displayed as the background information of the gesture inducement/relation pattern, the user may recognize that he or she must respectively touch the forefeet and tail end of the tiger with his or her fingers and must move the touching fingers leftwards.

When the inputs of the user are successively and accurately received at multiple steps, the number of multiple steps required for authentication may be decreased. Alternatively, when the input of the user at one of the multiple steps is unsuccessfully made (fails), an additional step may be required.

In order to solve the problem in which the user must go through several steps for personal authentication, a gesture inducement/relation pattern may be regenerated when the input of the user does not match part or all of the information about the enrolled fingertip gesture. The user may again input a fingertip gesture with respect to the regenerated gesture inducement/relation pattern. Here, the regenerated gesture inducement/relation pattern may have a high difficulty level or a normal difficulty level, compared to a normal gesture inducement/relation pattern.

When the gesture inducement/relation pattern is generated, a fake pattern 360 may be generated either in accordance with a predefined condition or randomly in certain situations.

The user may input a predefined fingertip gesture with respect to the fake pattern. In other words, the fake pattern may indicate the case where a predefined fingertip gesture must be input in order to recognize that a current pattern is a fake pattern, not the fingertip gesture enrolled by the user.

The fake pattern may be displayed together with background information or an entity that allows the user to identify the fake pattern. Alternatively, the fake pattern may be displayed together with a predefined background color, a predefined message, a predefined symbol, or a predefined sound effect that allows the user to identify the fake pattern. Alternatively, as the fake pattern, a random pattern that has not been previously viewed by the user may be displayed.

As described above, with respect to gesture inducement/relation patterns and fake patterns which are displayed at multiple steps, the user may input multiple fingertip gestures either randomly or sequentially, thus enabling personal authentication to be performed at different steps according to the environment.

The size of the background information or entity and one or more points may be generated based on geometric information about the hand geometry and/or the hand size of the user, which has been previously input. For example, one or more points determined according to the size of the background information or entity may correspond to the locations of fingertips of the user depending on the geometric information about the hand geometry and/or the hand size of the user.

When the user's fingertips touch the touch screen, the displayed pattern may disappear either at the moment at which the fingertip gesture is made or if a predefined time elapses after the fingertip gesture is made.

The order in which patterns are generated, background information, and entities may be generated differently depending on the time required for interaction between the fingertip gesture and the device, the touch order of fingertips, or the like.

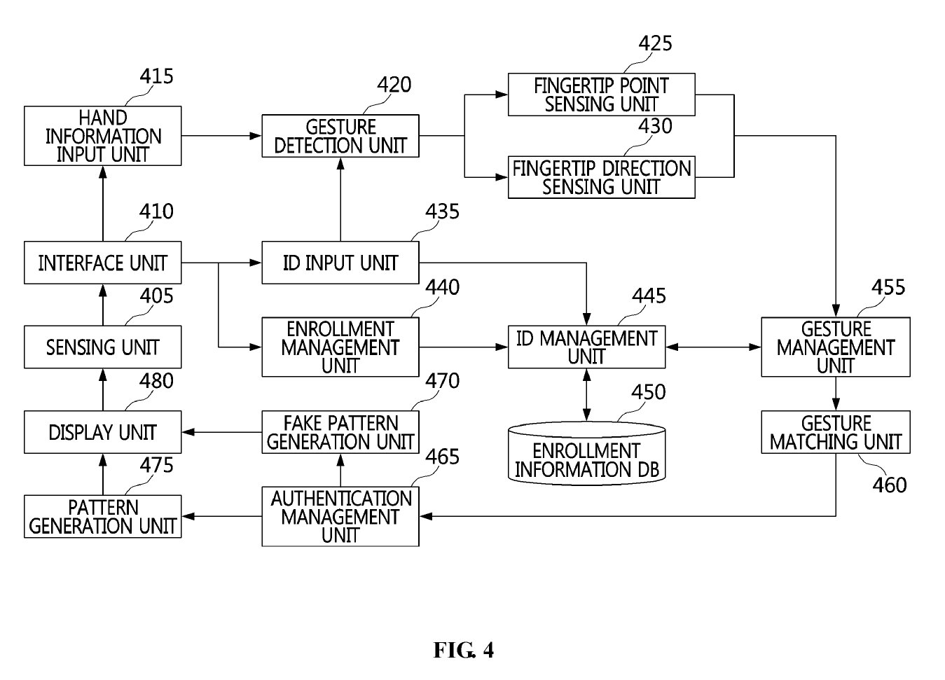

FIG. 4 is a configuration diagram of a personal authentication system based on the recognition of hand geometry and a fingertip gesture in a touch screen environment according to an embodiment.

A sensing unit 405, an interface unit 410, and a display unit 480 may correspond to the above-described sensor 110, interface 120, and display 130, respectively.

A hand information input unit 415, a gesture detection unit 420, a fingertip point sensing unit 425, a fingertip direction sensing unit 430, an ID input unit 435, a enrollment management unit 440, an ID management unit 445, a enrollment information database (DB) 450, a gesture management unit 455, a gesture matching unit 460, an authentication management unit 465, a fake pattern generation unit 470, and a pattern generation unit 475 may be program modules executed by the processor 140. Functions or operations, described as being performed by the program modules, may be considered to be performed by the processor 140. Alternatively, the processor 140 may include the hand information input unit 415, the gesture detection unit 420, the fingertip point sensing unit 425, the fingertip direction sensing unit 430, the ID input unit 435, the enrollment management unit 440, the ID management unit 445, the enrollment information database (DB) 450, the gesture management unit 455, the gesture matching unit 460, the authentication management unit 465, the fake pattern generation unit 470, and the pattern generation unit 475.

The fingertip gesture of the user may be input through the sensing unit 405.

Information about the input fingertip gesture may be transferred to the hand information input unit 415 through the interface unit 410.

When the ID of the user is input via the ID input screen 310, the ID input unit 435 may perform verification and processing as to the validity of a character string input as the user ID and as to whether the input of the user ID has been completed. The input character string may be transferred to the ID management unit 445.

When the user ID is enrolled, the enrollment management unit 440 may verify whether the user ID requested to be enrolled is valid, and may determine whether the user ID requested to be enrolled overlaps an ID previously enrolled in the enrollment information DB 450.

The ID management unit 445 may manage the input of a user ID, the enrollment of the user ID, and the enrollment information DB 450.

The ID management unit 445 may transfer information about the fingertip gesture of the user or the like to the gesture management unit 455.

The hand information input unit 415 may generate geometric information about hand geometry and/or hand morphology of the user when information about the user's hand is input via the sensor 110 or the touch screen.

The hand information input unit 415 may determine whether the user's hand touches the touch screen and whether information about the user's hand has been input through a procedure for analyzing a touch surface on the sensor 110 or the touch screen and verifying the hand geometry and/or the hand morphology of the user.

Unless information about a hand is input, the hand information input unit 415 may operate the gesture detection unit 420.

The gesture detection unit 420 may verify whether a fingertip gesture has been input by analyzing a touch surface on fingertips.

When the input of the fingertip gesture has been verified, the fingertip point sensing unit 425 may sense fingertip touch locations, the touch order of the fingertip touch locations, etc. with respect to the input fingertip gesture.

Further, when the input of the fingertip gesture has been verified, the fingertip direction sensing unit 430 may sense the moving direction of the fingertip touch locations.

The information about the fingertip gesture may include selective fingertip touch locations sensed by the fingertip point sensing unit 425, the touch order of the fingertip touch locations, and the moving direction of the fingertip touch locations sensed by the fingertip direction sensing unit 430.

The gesture management unit 455 may analyze and process similarity in a comparison item or the like for comparing similarity between information about the input fingertip gesture and information about the fingertip gesture of the enrolled user. The ID management unit 445 may search the enrollment information DB 450 for information about the fingertip gesture of the enrolled user. By analyzing and processing the similarity in the similarity comparison item or the like, whether the fingertip gesture of the user matches the fingertip gesture of the enrolled user may be efficiently determined based on the comparison.

The gesture matching unit 460 may produce the result of comparison of quantitative similarity through the determination of matching in the similarity comparison item.

The authentication management unit 465 may perform a subsequent step based on the produced result of the quantitative similarity comparison. The subsequent step may be the completion of authentication, (additional) authentication using a gesture inducement/relation pattern, or (additional) authentication using a fake pattern.

For example, when the result of the quantitative similarity comparison is equal to or greater than a predefined reference value, the authentication management unit 465 may determine that the input fingertip gesture has been successfully made. When the result of the quantitative similarity comparison is less than the predefined reference value, the authentication management unit 465 may determine that the input fingertip gesture has been unsuccessfully made.

For example, when the input fingertip gesture is successfully made, the authentication management unit 465 may complete authentication.

In an embodiment, when one or more predefined steps have been performed and the input fingertip gesture has been successfully made, the authentication management unit 465 may complete authentication.

In an embodiment, when the input fingertip gesture is successfully made, the authentication management unit 465 may proceed to perform authentication that uses a subsequent gesture inducement/relation pattern as a subsequent step.

In an embodiment, when the input fingertip gesture is unsuccessfully made, the authentication management unit 465 may proceed to perform authentication that uses a subsequent gesture inducement/relation pattern as a subsequent step.

In an embodiment, when the input fingertip gesture is successfully made, the authentication management unit 465 may generate a fake pattern and may proceed to perform authentication that uses the fake pattern as a subsequent step.

In an embodiment, when the input fingertip gesture is unsuccessfully made, the authentication management unit 465 may generate a fake pattern and may proceed to perform authentication that uses the fake pattern as a subsequent step.

When authentication using a fake pattern is performed, the fake pattern generation unit 470 may generate a fake pattern. The fake pattern generation unit 470 may randomly generate fake patterns having various difficulty levels.

When authentication using the gesture inducement/relation pattern is performed, the pattern generation unit 475 may generate a gesture inducement/relation pattern.

When the fake pattern or the gesture inducement/relation pattern is generated, the display unit 480 may display the fake pattern or the gesture inducement/relation pattern, and may repeat operations performed through the sensing unit 405, the interface unit 410, the hand information input unit 415, etc.

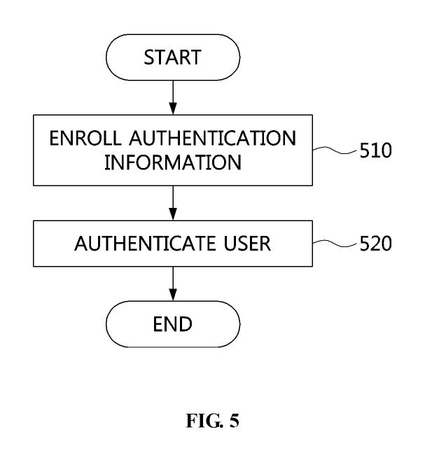

FIG. 5 is a flowchart of an authentication method according to an embodiment.

At step 510, the authentication apparatus 100 may enroll authentication information required for the authentication of the user. The authentication information may contain information about a fingertip gesture.

At step 520, the authentication apparatus 100 may authenticate the user.

The authentication apparatus 100 may authenticate the user based on the recognition of a hand geometry and/or a hand size, the recognition of the fingertip gesture, the identification of a fake pattern, etc.

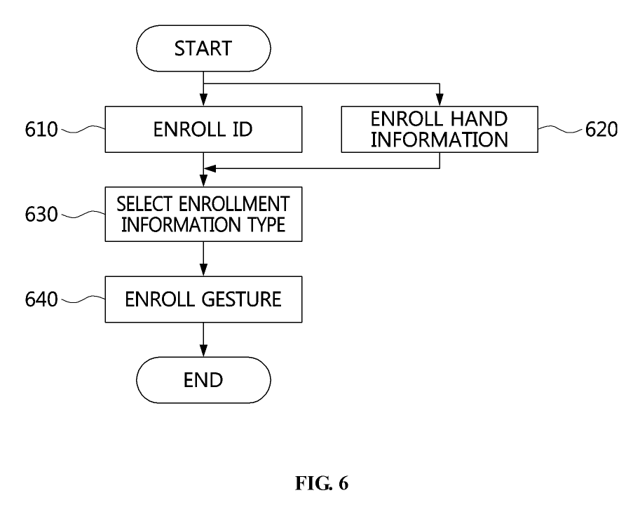

FIG. 6 is a flowchart illustrating a method of enrolling authentication information according to an embodiment.

Step 510, described above with reference to FIG. 5, may include steps 610, 620, 630, and 640, which will be described below.

At steps 610 and 620, the authentication apparatus 100 may enroll information for identifying the user.

The information for identifying the user may include the user ID and hand information of the user.

The hand information of the user may include geometric information about the hand geometry and/or the hand size of the user.

At step 610, the authentication apparatus 100 may enroll the user ID.

At step 620, the authentication apparatus 100 may enroll the hand information of the user.

At step 630, the authentication apparatus 100 may select the type of enrollment information related to a fingertip gesture.

The enrollment information may be background-based enrollment information or non-background fingertip point-based enrollment information. A background may be a picture or a drawing. The type of enrollment information may be selected by the user or the authentication apparatus 100.

At step 640, the authentication apparatus 100 may enroll a fingertip gesture. The detailed method for enrolling the fingertip gesture may differ according to the type of selected enrollment information.

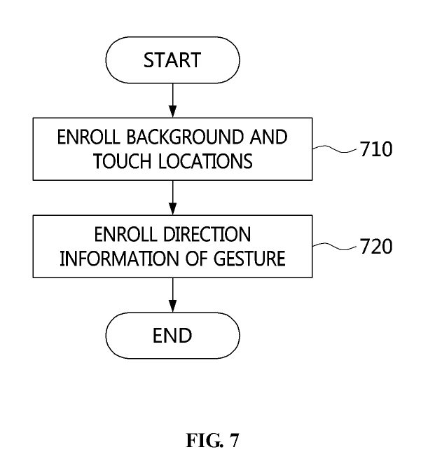

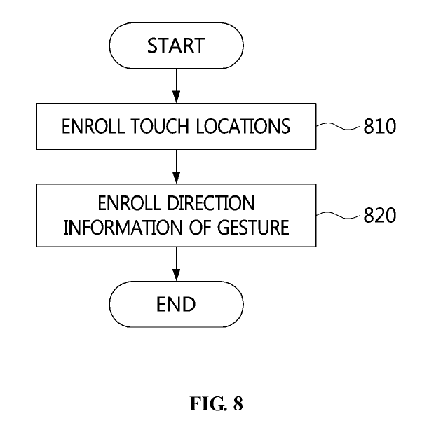

The case where background-based enrollment information is enrolled will be described in detail later with reference to FIG. 7. The case where non-background fingertip point-based enrollment information is enrolled will be described in detail later with reference to FIG. 8.

Steps 630 and 640 may be repeated a number of times that are identical to the number of times required by the authentication apparatus 100, and the enrollment procedure may be terminated after steps 630 and 640 are repeated.

FIG. 7 is a flowchart illustrating a method for enrolling background-based enrollment information according to an example.

Step 640, described above with reference to FIG. 6, may include steps 710 and 720, which will be described below.

At step 710, the authentication apparatus 100 may enroll a background and fingertip touch locations.

The touch screen may display pictures and drawings corresponding to the background. Any of background pictures or drawings may be selected by the user or the authentication apparatus 100, and an entity in the corresponding picture or drawing may be selected.

When the entity is selected, the touch screen may display one or more points of the entity in the background. One or more fingertip touch locations may be selected from among the one or more points of the entity and then enrolled by the user or the authentication apparatus 100. In other words, points to be touched by the fingertip gesture, among the one or more points of the pattern, may be some of the one or more points. The user may touch some point(s) of the one or more points of the pattern, and the some point(s) that are touched may be enrolled as a part of the fingertip gesture with respect to the pattern.

Further, the touch order of the one or more fingertip touch locations may be selected and enrolled by the user or the authentication apparatus 100.

The pattern may include marks indicating one or more points. For example, the pattern may include one or more circles having one or more points as respective centers.

When one or more points are displayed on the touch screen, the size and/or shape of an entity such as an animal or a character may be generated or adjusted based on the initially input geometric information about the hand geometry and/or the hand size of the user. Further, when one or more points of an entity are displayed on the touch screen, the locations of the one or more points of an entity such as an animal or a character may be determined and adjusted based on the geometric information about the hand geometry and/or the hand size of the user. Therefore, the locations of the one or more points of the entity may be automatically adjusted based on the geometric information about the hand geometry and/or the hand size of the user.

At step 720, when the fingertip touch locations are determined, the user or the authentication apparatus 100 may select and enroll the moving direction of the fingertip touch locations.

The moving direction of the one or more fingertip touch locations may differ from each other. For example, the moving direction of the one or more fingertip touch locations may be a direction leading away from a specific reference point or leading closer to the specific reference point.

FIG. 8 is a flowchart illustrating a method for enrolling non-background fingertip point-based enrollment information according to an example.

Step 640, described above with reference to FIG. 6, may include steps 810 and 820, which will be described below.

The non-background fingertip point-based enrollment information may also be enrolled in the same way as the above-described background-based enrollment information.

At step 810, the authentication apparatus 100 may enroll fingertip touch locations.

The touch screen may display one or more points. For example, the points may have circular shapes. One or more fingertip touch locations may be selected from among the one or more points and then enrolled by the user or the authentication apparatus 100. Further, the touch order of the one or more fingertip touch locations may be selected and enrolled by the user or the authentication apparatus 100.

When one or more points are displayed on the touch screen, the locations of the one or more points may be generated and/or adjusted based on geometric information about the hand geometry and/or the hand size of the user.

For example, as the size of the user's hand is larger, intervals between the locations of the one or more points may be further increased.

For example, the locations of the one or more points may correspond to the locations of the fingertips of the user when the user suitably opens his or her hand to such an extent as to touch the points. Therefore, the locations of the one or more points may be automatically adjusted based on the geometric information about the hand geometry and/or the hand size of the user.

At step 820, when the fingertip touch locations are determined, the user or the authentication apparatus 100 may select and enroll the moving direction of the fingertip touch locations.

The description of the above embodiments, made above with reference to FIG. 7, may also be applied to the present embodiment except for the description related to the display of a background.

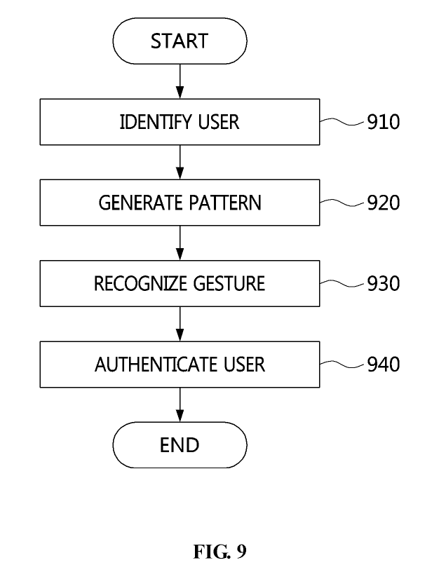

FIG. 9 is a flowchart illustrating a user authentication method according to an embodiment.

Step 520, described above with reference to FIG. 5, may include steps 910, 920, 930, and 940, which will be described below.

At step 910, the authentication apparatus 100 may identify the user.

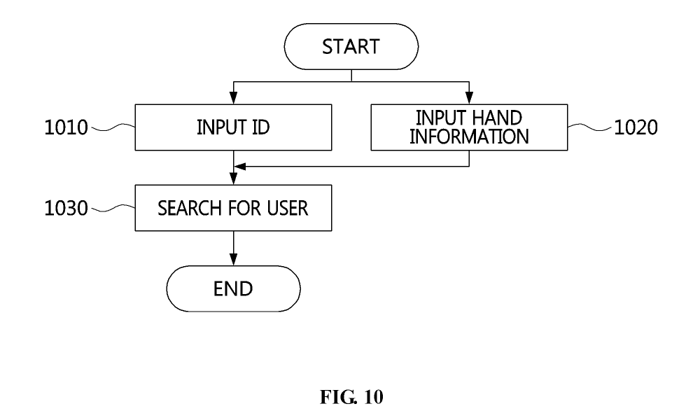

The identification of the user will be described in detail later with reference to FIG. 10.

The authentication apparatus 100 may decrease the range of user search at step 920, which will be described later, by identifying the user, and may sequentially perform authentication of the user at the following steps 920, 930, and 940.

When the user is identified, information about a fingertip gesture enrolled by the identified user may be searched for. The authentication apparatus 100 may search the enrollment information DB 450 for information about the enrolled fingertip gesture.

At step 920, the authentication apparatus 100 may generate a pattern to receive a fingertip gesture for authenticating the user, and may display the generated pattern.

The pattern may be a gesture inducement/relation pattern or a fake pattern.

The pattern may be generated based on geometric information about the hand geometry and/or the hand size of the identified user.

The gesture inducement/relation pattern may be a pattern for acquiring the fingertip gesture enrolled by the user. The fake pattern may be a pattern for acquiring a predefined fingertip gesture. In other words, the gesture inducement/relation pattern may be a “pattern (enrolled by the user for the authentication of the user)” and the fake pattern may be an “unenrolled pattern” or a “predefined pattern (for all users)”.

At step 930, the authentication apparatus 100 may recognize the fingertip gesture of the user with respect to the pattern. The authentication apparatus 100 may recognize the fingertip gesture via interaction with the user with respect to the pattern.

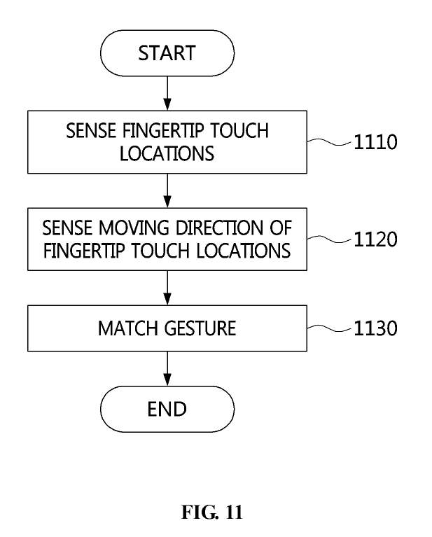

The recognition of a fingertip gesture with respect to the gesture inducement/relation pattern will be described in detail later with reference to FIG. 11.

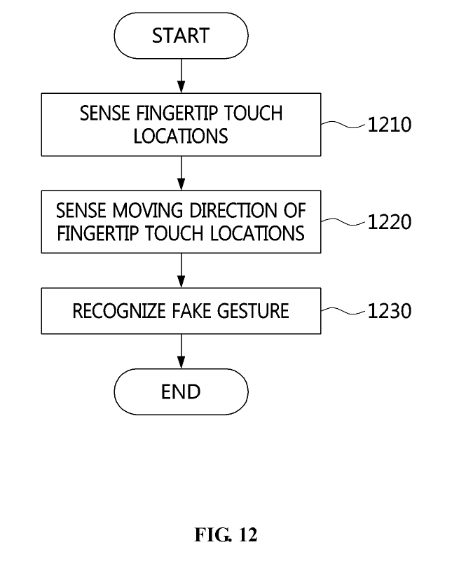

The recognition of a fingertip gesture with respect to the fake pattern will be described in detail later with reference to FIG. 12.

At step 940, the authentication apparatus 100 may authenticate the user using the recognized fingertip gesture.

For example, when the input fingertip gesture is successfully made, the authentication apparatus 100 may determine that the authentication of the user has succeeded. When the input fingertip gesture is unsuccessfully made, the authentication apparatus 100 may determine that the authentication of the user has failed.

Steps 920, 930, and 940 may be repeatedly performed. When the authentication of the user succeeds a predetermined number of times, the authentication apparatus 100 may finally complete the authentication of the user.

FIG. 10 is a flowchart illustrating a user identification method according to an embodiment.

Step 910, described above with reference to FIG. 9, may include steps 1010, 1020, and 1030, which will be described below.

At step 1010, a user ID may be input by the user to the authentication apparatus 100. The authentication apparatus 100 may identify the user by searching the enrollment information DB 450 using the input user ID.

At step 1020, information about the user's hand may be input by the user to the authentication apparatus 100. The authentication apparatus 100 may identify the user by searching the enrollment information DB 450 using the input hand information.

Steps 1010 and 1020 may be selectively performed. For example, the input of the user ID may be omitted. Alternatively, the user ID and the user hand information may be simultaneously input to the authentication apparatus 100.

The hand information may include geometric information about hand geometry and/or hand morphology.

At step 1030, the authentication apparatus 100 may search the enrollment information DB 450 for information about candidate users matching the input user ID and the input hand information using the input user ID and/or the input hand information. By searching for the candidate user information, the user may be identified. Among users enrolled in the enrollment information DB 450, a user found as the result of the search may be identified as the user of the current authentication apparatus 100.

The authentication apparatus 100 may decrease the range of user search at the subsequent step 920 by identifying the user, and may sequentially authenticate the user at steps 920, 930, and 940.

FIG. 11 is a flowchart illustrating a method for recognizing a fingertip gesture with respect to a gesture inducement/relation pattern according to an embodiment.

Step 930, described above with reference to FIG. 9, may include steps 1110, 1120, and 1130, which will be described below.

When the fingertip gesture of the user is input with respect to a gesture inducement/relation pattern, steps 1110, 1120, and 1130 may be performed.

At step 1110, the authentication apparatus 100 may sense selective fingertip touch locations, the touch order of the fingertip touch locations, etc. with respect to the input fingertip gesture.

At step 1120, the authentication apparatus 100 may sense the moving direction of the fingertip touch locations.

Information about the fingertip gesture may include selective fingertip touch locations, the touch order of the fingertip touch locations, and the moving direction of the fingertip touch locations.

At step 1130, the authentication apparatus 100 may recognize a fingertip gesture with respect to the gesture inducement/relation pattern.

The authentication apparatus 100 may analyze and process similarity in a comparison item or the like for comparing similarity between information about the input fingertip gesture and information about the fingertip gesture of the user found as the result of the search (i.e. the enrolled user).

The authentication apparatus 100 may search the enrollment information DB 450 for information about the fingertip gesture of the enrolled user. By analyzing and processing the similarity in the similarity comparison item, whether the input fingertip gesture matches the fingertip gesture of the enrolled user may be efficiently determined based on the comparison.

The authentication apparatus 100 may produce the result of comparison of quantitative similarity through the determination of matching in the similarity comparison item.

The authentication apparatus 100 may determine whether the input fingertip gesture is a gesture that successfully or unsuccessfully matches the gesture inducement/relation pattern via the comparison of similarity between the information about the input fingertip gesture and the information about the fingertip gesture of the enrolled user.

For example, when the result of the quantitative similarity comparison, which has been produced through a comparison between the information about the input fingertip gesture and the information about the enrolled fingertip gesture of the enrolled user, is equal to or greater than a predefined reference value, the authentication apparatus 100 may determine that the input fingertip gesture has been successfully made. In contrast, when the result of the quantitative similarity comparison is less than the predefined reference value, the authentication apparatus 100 may determine that the input fingertip gesture has been unsuccessfully made.

FIG. 12 is a flowchart illustrating a method for recognizing a fingertip gesture with respect to a fake pattern according to an embodiment.

Step 930, described above with reference to FIG. 9, may include steps 1210, 1220, and 1230, which will be described below.

When the fingertip gesture of the user is input with respect to a fake pattern, steps 1210, 1220, and 1230 may be performed.

At step 1210, the authentication apparatus 100 may sense selective fingertip touch locations, the touch order of the fingertip touch locations, etc. with respect to the input fingertip gesture.

At step 1220, the authentication apparatus 100 may sense the moving direction of the fingertip touch locations.

Information about the fingertip gesture may include selective fingertip touch locations, the touch order of the fingertip touch locations, and the moving direction of the fingertip touch locations.

At step 1230, the authentication apparatus 100 may recognize a fingertip gesture with respect to the fake pattern.

The authentication apparatus 100 may analyze and process similarity in a comparison item for comparing similarity between information about the input fingertip gesture and information about a predefined fingertip gesture with respect to the fake pattern. The authentication apparatus 100 may determine whether the input fingertip gesture matches the predefined fingertip gesture with respect to the fake pattern.

By analyzing and processing the similarity in the similarity comparison item, whether the input fingertip gesture matches the predefined fingertip gesture with respect to the fake pattern may be efficiently determined based on the comparison.

The authentication apparatus 100 may produce the result of comparison of quantitative similarity through the determination of matching in the similarity comparison item.

For example, when the result of the quantitative similarity comparison is equal to or greater than a predefined reference value, the authentication apparatus 100 may determine that the input fingertip gesture has been successfully made. When the result of the quantitative similarity comparison is less than the predefined reference value, the authentication apparatus 100 may determine that the input fingertip gesture has been unsuccessfully made.

The apparatus described herein may be implemented using hardware components, software components, or a combination thereof. For example, the apparatus and components described in the embodiments may be implemented using one or more general-purpose or special-purpose computers, for example, a processor, a controller, an arithmetic logic unit (ALU), a digital signal processor, a microcomputer, a field programmable array (FPA), a programmable logic unit (PLU), a microprocessor or any other apparatus (device) capable of responding to and executing instructions. A processing device may run an operating system (OS) and one or more software applications that run on the OS. The processing device may also access, store, manipulate, process, and create data in response to execution of the software. For convenience of understanding, the use of a single processing device is described, but those skilled in the art will understand that a processing device may comprise multiple processing elements and multiple types of processing elements. For example, a processing device may include multiple processors or a single processor and a single controller. Also, different processing configurations, such as parallel processors, are possible.

The software may include a computer program, code, instructions, or some combination thereof, and it is possible to configure processing devices or to independently or collectively instruct the processing devices to operate as desired. Software and data may be embodied permanently or temporarily in any type of machine, component, physical or virtual equipment, computer storage medium, or device, or in a propagated signal wave in order to provide instructions or data to the processing devices or to be interpreted by the processing devices. The software may also be distributed in computer systems over a network such that the software is stored and executed in a distributed manner. In particular, the software and data may be stored in one or more computer-readable recording media.

The above-described embodiments may be implemented as a program that can be executed by various computer means. In this case, the program may be recorded on a computer-readable storage medium. The computer-readable storage medium may include program instructions, data files, and data structures, either solely or in combination. Program instructions recorded on the storage medium may have been specially designed and configured for the present disclosure, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as Compact Disk-Read Only Memory (CD-ROM) and a Digital Versatile Disk (DVD), magneto-optical media, such as a floptical disk, ROM, Random Access Memory (RAM), and flash memory. Examples of the program instructions include machine code, such as code created by a compiler, and high-level language code executable by a computer using an interpreter. The hardware devices may be configured to operate as one or more software modules in order to perform the operation of the present disclosure, and vice versa.

As described above, there provided an apparatus and method for providing a pattern that enables interaction with a user based on the geometric range of a hand geometry and/or a hand size when biometric information about the hand geometry and/or the hand size is enrolled via a touch screen.

There are provided an apparatus and method for authenticating a user via continuous interaction with a pattern and a fingertip gesture.

There are provided an apparatus and method for authenticating a user using gesture inducement/relation patterns and fake patterns which are displayed either in a predefined order or in a random order.

There are provided an apparatus and method for authenticating a user, which exploit both biometric information about a hand geometry and/or a hand size, each of which has uniqueness insufficient to identify each individual, and a fingertip gesture, which is capable of supplementing the biometric information.

There are provided an apparatus and method for simultaneously providing advantages, such as convenience of use, which is provided by a conventional personal authentication method using a password or a PIN, and strengthened security, which is provided by a conventional biometrics method, by exploiting both the biometric information and the fingertip gesture.

There are provided an apparatus and method for continuously recognizing various fingertip gestures that are reissuable and regenerable to strengthen safety and security, based on soft biometrics using biometric information about a hand geometry and/or a hand size.

There are provided an apparatus and method for more securely and efficiently authenticating a user via soft biometrics and recognition of fingertip gestures.

There are provided an apparatus and method for authenticating a user without using an additional sensor by utilizing a touch screen, widely used in various products, technologies and applications, without change.

There are provided an apparatus and method for authenticating a user, which may be implemented without modifying or adding hardware in existing smart devices, computer systems, Automated Teller Machine (ATM) devices, and access control systems that use touch screens.

Although the embodiments have been disclosed for illustrative purposes, those skilled in the art will appreciate that various modifications, additions and substitutions are possible, without departing from the scope and spirit of the invention. For example, if the described techniques are performed in a different order, if the described components, such as systems, architectures, devices, and circuits, are combined or coupled with other components by a method different from the described methods, or if the described components are replaced with other components or equivalents, the results are still to be understood as falling within the scope of the present disclosure.

What is claimed is:

1. An authentication method, comprising:
identifying a user;
displaying a pattern generated based on geometric information about a hand geometry or a hand size of the identified user;
recognizing a fingertip gesture via interaction with the user with respect to the pattern; and
authenticating the user using the recognized fingertip gesture.

2. The authentication method of claim 1, wherein:
identifying the user is configured to search for information about candidate users matching input hand information by exploiting the input hand information, and
the hand information includes geometric information about hand geometry or hand morphology.

3. The authentication method of claim 1, wherein:
the pattern is a gesture inducement/relation pattern, and
the gesture inducement/relation pattern is a pattern for acquiring a fingertip gesture enrolled by the user.

4. The authentication method of claim 3, wherein recognizing the fingertip gesture comprises:
sensing fingertip touch locations of an input fingertip gesture;
sensing a moving direction of the fingertip touch locations; and
determining whether the input fingertip gesture is a gesture that has been successfully made with respect to the gesture inducement/relation pattern by comparing similarity between the information about the input fingertip gesture and information about the enrolled fingertip gesture,
wherein the information about the input fingertip gesture includes the fingertip touch locations and the moving direction.

5. The authentication method of claim 4, wherein if a result of a quantitative similarity comparison, produced through a comparison between the information about the input fingertip gesture and the information about the enrolled fingertip gesture, is equal to or greater than a predefined reference value, it is determined that the input fingertip gesture has been successfully made.

6. The authentication method of claim 4, wherein the information about the input fingertip gesture further includes a touch order of the fingertip touch locations.

7. The authentication method of claim 4, wherein:
an entity is displayed as a background together with the gesture inducement/relation pattern,
the entity indicates one or more points, and
each of the one or more points is a region that is separately identifiable within the entity.

8. The authentication method of claim 7, wherein the one or more points are generated based on the geometric information about the hand geometry or the hand size of the user.

9. The authentication method of claim 8, wherein the one or more points correspond to locations of the fingertips of the user depending on the geometric information about the hand geometry or the hand size of the user.

10. The authentication method of claim 1, wherein the pattern disappears either at a moment at which the fingertip gesture is made or if a predefined time elapses after the fingertip gesture is made.

11. The authentication method of claim 1, wherein:
the pattern is a fake pattern, and
the fake pattern is a pattern for acquiring a predefined fingertip gesture.

12. A method for enrolling authentication information, comprising:
enrolling information for identifying a user; and
enrolling a fingertip gesture of the user,
wherein information for identifying the user includes geometric information about a hand geometry or a hand size of the user.

13. The method of claim 12, further comprising selecting a type of enrollment information related to the fingertip gesture,
wherein the enrollment information is background-based enrollment information or non-background fingertip point-based enrollment information.

14. The method of claim 12, wherein enrolling the fingertip gesture comprises:
enrolling a background and fingertip touch locations of the fingertip gesture; and
enrolling a moving direction of the fingertip touch locations.

15. The method of claim 14, wherein enrolling the fingertip touch locations is configured such that, when one or more points in an entity of the background are displayed, one or more fingertip touch locations are selected from among the one or more points and then enrolled.

16. The method of claim 15, wherein the entity has a size or a shape that is generated or adjusted based on the geometric information about the hand geometry or the hand size of the user.

17. The method of claim 14, wherein enrolling the fingertip touch locations is configured to enroll a touch order of the one or more fingertip touch locations of the fingertip gesture.

18. The method of claim 12, wherein enrolling the fingertip gesture comprises:
enrolling fingertip touch locations of the fingertip gesture; and
enrolling a moving direction of the fingertip touch locations,
wherein enrolling the fingertip touch locations is configured to display one or more points, select one or more fingertip touch locations from among the one or more points, and enroll the selected one or more fingertip touch locations.

19. The method of claim 18, wherein locations of the one or more points are generated or adjusted based on the geometric information about the hand geometry or the hand size of the user.

20. An authentication apparatus, comprising:
a display for displaying a pattern generated based on geometric information about a hand geometry or a hand size of a user; and
a processor for recognizing a fingertip gesture via interaction with the user with respect to the pattern and authenticating the user using the recognized fingertip gesture.
